(19) United States
(12) Patent Application Publication
(10) Pub. No.: US 2025/0345155 A1
(43) Pub. Date: Nov. 13, 2025

(54) FULL-MOUTH ZIRCONIA IMPLANT SYSTEM AND METHOD FOR FULL MOUTH RECONSTRUCTION USING ONE-PIECE CERAMIC ZIRCONIA DENTAL IMPLANTS

(71) Applicant: Azadeh Khajavi, San Diego, CA (US)

(72) Inventor: Azadeh Khajavi, San Diego, CA (US)

(21) Appl. No.: 19/201,449

(22) Filed: May 7, 2025

Related U.S. Application Data
(60) Provisional application No. 63/643,460, filed on May 7, 2024.

(51) Int. Cl. A61C 8/00; A61C 9/00; A61C 13/107

(52) U.S. Cl. CPC A61C 8/0095; A61C 8/0012; A61C 9/0006; A61C 9/004; A61C 13/0001

(57) ABSTRACT

The present disclosure discloses full-mouth zirconia implant method and system for full mouth reconstruction using one-piece ceramic zirconia dental implants. The full-mouth zirconia implant method comprises acquiring analog and digital impressions of tooth of patients; fabricating a temporary restoration based on acquired impressions; adapting medical professionals for administering anesthesia to the patients; placing the one-piece ceramic zirconia dental implants in a jaw of the patients; preparing at least four unextracted tooth for anchoring temporary restoration; anchoring and seating the temporary restoration on at least four unextracted tooth for avoiding premature contact with abutments of one-piece ceramic zirconia dental implants; initiating prosthodontic phase after healing period upon performing post-operative care; assessing smile of patients to determine whether an occlusal plane is parallel to a line connecting a tragus of an ear to an ala of nose of the patients; and placing a final restoration for the full mouth reconstruction.

### CROSS REFERENCE TO RELATED APPLICATION(S)

This application claims the priority to incorporate by reference the entire disclosure of U.S. provisional patent application No. 63/643,460 filed on May 7, 2025 titled “PROCESS FOR FULL MOUTH RECONSTRUCTION USING ONE-PIECE CERAMIC ZIRCONIA DENTAL IMPLANTS”.

### TECHNICAL FIELD

Embodiments of the present disclosure relate to dental implants, and more particularly relate to full-mouth zirconia implant system and method with one or more one-piece ceramic zirconia dental implants that enhance efficiency and minimize potential complications in dental implant procedures of a fully edentulous patient.

### BACKGROUND

Patients facing dental issues experience a range of oral health problems that significantly impact their well-being. The dental issues include tooth decay, gum disease, sensitivity, bad breath, missing teeth, teeth grinding, misalignment, malocclusion, traumatic injuries, and temporomandibular joint disorders. The dental issues arise from factors including inadequate oral hygiene, genetic predispositions, aging, and external trauma. Neglecting the dental issues results in pain, discomfort, and chewing difficulties, which gives rise to broader health-related complications if not addressed. Patients should consult a dentist for precise diagnoses and proper treatment of the dental issues. Regular check-ups, along with the consistent oral hygiene practices, are vital for maintaining optimal dental health and preventing the progression of the dental issues.

The patients experiencing the tooth decay, gum disease, missing teeth, worn down teeth, malocclusion, traumatic injuries, and temporomandibular joint disorders are advised to contemplate a thorough full mouth restoration. The full mouth restoration is a comprehensive dental treatment that involves restoring the optimal dental health, function, and appearance of all teeth in both upper jaws and lower jaws. A process of the full mouth restoration begins with a thorough examination and assessment of the oral health of the patient, including the teeth, gums, jaw joints, and bite alignment. Based on an evaluation, a personalized treatment plan is developed, which includes a combination of procedures including fillings, crowns, bridges, dental implants, and orthodontics. The full mouth restoration aims to address all aspects of the oral health, from repairing damaged teeth to addressing the gum disease and restoring proper bite function. The full mouth restoration greatly improves the overall quality of life of the patients, by enhancing their ability to eat, speak, and smile comfortably and confidently.

Some conditions adversely affect the entire teeth of the patients, where the teeth are not salvageable which means a terminal dentition. As a result, all of the teeth must be removed. In such cases, the patients are provided with the options of a removable denture 100 (as shown in FIG. 1), a hybrid denture where the patient gets titanium posts then the denture gets fixated that is screwed onto the titanium posts, and the full mouth restoration.

For the hybrid denture 200 (as shown in FIG. 2), a bone is ground down to a base of a nose (15-18 mm) using a reduction guide. This is done to create space for the denture to fit in permanently. Then 4-5 titanium dental implants are inserted inside a flattened bone. Usually, the titanium dental implants in an anterior are inserted axially, and the titanium dental implants in posteriors are at angles. The reason for this is to avoid perforating a sinus in an upper jaw and to avoid cutting a nerve in a bottom jaw. In an FP1: only crowns need to be replaced which are seated on the titanium dental implants. In an FP2: a small part of a gingiva and the crown are replaced. In an FP3: the bone, the gingiva, and the tooth are being replaced. So basically, an FP3 appliance is the denture configured with the white teeth, pink gums, and some attachment for multi-unit abutments.

Fabrication of the FP3 appliance, the denture (denture teeth, plus the pink acrylic gum), plus the multi-unit abutments to connect the denture to the titanium dental implants requires an average of 18 millimeters of a space in the oral cavity. Therefore, the dentists frequently use a reduction guide and indiscriminately shave off the bone to create the space. This is the reduction approach. Hypersensitivity to titanium particles or ions released from a titanium dental implant surface also affects titanium dental implant survival. Corrosion of the titanium dental implant surface which is the degeneration of a titanium dioxide layer liberates where particles that induce inflammatory reactions in peri-implant tissues. The particles are recognized as foreign-body substances and phagocytosed by macrophages. Later, ml cells release inflammatory cytokines that promote osteoclastogenesis and osteolysis.

Conventionally, the titanium dental implants are widely employed for replacing the missing teeth. The titanium dental implants are made from a medical-grade titanium, a biocompatible material that is well-tolerated by a human body. However, the titanium dental implants lead to inflammation that affects tissues surrounding the titanium dental implants.

Furthermore, a two-piece zirconia dental implant system comprises an implant fixture and an abutment. The implant fixture is surgically positioned into a jawbone, serving as an artificial root to support a tooth replacement. The abutment is attached to the implant fixture after a period of healing and integration with the jawbone. The abutment protrudes above a gumline and provides a connecting point for a final restoration, including the crown, the bridge, and the denture. However, the two-piece zirconia dental implant develops structural weakness around the jawbone. While chewing, the two-piece zirconia dental implant experiences a fracture.

In the existing technology, a fabrication and installation of the dental implant are disclosed. The dental implant comprises an implant member for insertion into a periodontal bone socket of an extracted natural tooth and an anchoring assembly. The implant member substantially resembles a natural tooth. The implant member comprises a coronal section and a root section. The root section of the implant member comprises a coronal end, a mid-portion, and a conical apical end. The coronal section axially extends from the coronal end of the root section. The implant member further comprises multiple hook-shaped extensions circumferentially disposed around the root section of the implant member. The anchoring assembly is positioned within a hollow axial cavity of the implant member. However, an invasive surgery damages a periodontal tissue and a supporting bone and results in a potential loss of stability and retention of the dental implant.

There are various technical problems with the dental implants in the prior art. In the existing technology, the surgical placement of the dental implants results in temporary discomfort, swelling, and necessitates a period of post-operative recovery. The dental implants take several months to integrate with the jawbone completely. The patients face an allergic reaction to materials used in the dental implants. An adjacent tooth requires modification to accommodate the dental implants, potentially affecting a natural structure of the teeth. Additionally, the dental implants fail to resemble the natural tooth. Furthermore, the fracture occurs in the dental implants during the chewing process.

The structural weakness is found in traditional two-piece dental implants. A micro gap in the two-piece dental implants is associated with the presence of inflammatory cell infiltrate, which leads to crestal bone loss by affecting both soft tissues and hard tissues. A pumping effect of a liquid saliva contained in the cavities moves into a peri-implant compartment due to a cyclical loading of a implant-abutment interface and facilitates a colonization of the micro gap and inner walls of the two-piece dental implants by a gram-positive bacteria and a gram-negative bacteria. These organic fluids with bacterial by-products and endotoxins regulate the expression of proinflammatory cytokines in peri-implant tissues and stimulate the chemotaxis of active osteoclasts.

Therefore, there is a need for a process to address the aforementioned issues by providing a full-mouth zirconia implant method and system having comprehensive and effective solution that replaces the missing teeth and restores oral function, aesthetics, and confidence in the patients.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In order to overcome the above deficiencies of the prior art, the present disclosure is to solve the technical problem by providing full-mouth zirconia implant method and system for mouth reconstruction using one or more one-piece ceramic zirconia dental implants, thereby replacing missing teeth and restoring oral function, aesthetics, and confidence in the patients. The process for mouth reconstruction using one or more one-piece ceramic zirconia dental implants is also referred to as “All On Z One Piece Technique”.

In accordance with an embodiment of the present disclosure, full-mouth zirconia implant method for full mouth reconstruction using one or more one-piece ceramic zirconia dental implants, is disclosed. The full-mouth zirconia implant method comprises acquiring one or more analog impressions and one or more digital impressions of one or more tooth of one or more patients. The full-mouth zirconia implant method further comprises fabricating a temporary restoration based on at least one of: the acquired one or more analog impressions and the acquired one or more digital impressions.

The full-mouth zirconia implant method further comprises adapting one or more medical professionals for administering anesthesia to the one or more patients. The full-mouth zirconia implant method further comprises creating one or more vertical incision lines before Mucocutaneous Junctions (MC) s) on a face of the one or more patients. The full-mouth zirconia implant method further comprises placing the one or more one-piece ceramic zirconia dental implants in a jaw of the one or more patients. The full-mouth zirconia implant method further comprises preparing at least four unextracted tooth for anchoring the temporary restoration. The full-mouth zirconia implant method further comprises suturing gum tissue around the one or more one-piece ceramic zirconia dental implants and at least four unextracted tooth, for optimizing an amount of keratinized tissue around the one or more one-piece ceramic zirconia dental implants. The full-mouth zirconia implant method further comprises anchoring and seating the temporary restoration on the at least four unextracted tooth for avoiding premature contact with one or more abutments of the one or more one-piece ceramic zirconia dental implants.

The full-mouth zirconia implant method further comprises performing suturing around the temporary restoration to support optimized gum healing and shaping around the temporary restoration. The full-mouth zirconia implant method further comprises utilizing a cement for the temporary restoration for providing stability during a healing period. The full-mouth zirconia implant method further comprises performing post-operative care. The post-operative care involves employing one or more hygiene protocols including antibacterial mouth rinses, warm salt water, and a waterpik, on the temporary restoration to prevent infections. The full-mouth zirconia implant method further comprises initiating a prosthodontic phase after the healing period upon performing the post-operative care. The full-mouth zirconia implant method further comprises assessing smile of the one or more patients to determine whether an occlusal plane is parallel to a line connecting a tragus of an ear to an ala of the nose of the one or more patients. The full-mouth zirconia implant method further comprises placing a final restoration for the full mouth reconstruction.

In an embodiment, the full-mouth zirconia implant method further comprises performing bone augmentation prior to placing the one or more one-piece ceramic zirconia dental implants.

In another embodiment, the full-mouth zirconia implant method further comprises optimizing sculpting and preparing the one or more one-piece ceramic zirconia dental implants for adapting one or more ceramic crowns to be placed on the one or more one-piece ceramic zirconia dental implants.

In yet another embodiment, the full-mouth zirconia implant method further comprises performing a ridge splitting technique to accommodate the one or more one-piece ceramic zirconia dental implants in areas of inadequate bone width.

In yet another embodiment, the full-mouth zirconia implant method further comprises initiating the prosthodontic phase after the healing period, comprises: (a) evaluating osseointegration of the one or more one-piece ceramic zirconia dental implants, after the healing period; (b) analyzing at least one of: aesthetics, phonetics, and occlusion, of the temporary restoration worn by the one or more patients during the healing period; (c) performing at least one of: intraoral scans of upper and lower temporary restorations, and one or more scans of upper and lower teeth in maximum intercuspation; (d) extracting the at least four unextracted tooth that anchored the temporary restoration during healing; (e) sculpting and modifying the one or more one-piece ceramic zirconia dental implants to create proper spacing, alignment, and margins, for the final restoration; (f) taking one or more impressions of the prepared one or more one-piece ceramic zirconia dental implants for fabrication of the final restoration; (g) constructing the one or more ceramic crowns based on at least one of: the one or more impressions and one or more digital scans; and (h) placing the one or more ceramic crowns onto the one or more one-piece ceramic zirconia dental implants.

In yet another embodiment, placing the final restoration comprises arranging each ceramic crown of the one or more ceramic crowns for each of the one or more one-piece ceramic zirconia dental implants.

In yet another embodiment, the one or more one-piece ceramic zirconia dental implants are placed immediately after tooth extraction.

In yet another embodiment, the temporary restoration is configured to avoid occlusion with the one or more one-piece ceramic zirconia dental implants during the healing period.

In yet another embodiment, the one or more one-piece ceramic zirconia dental implants are placed without significant bone reduction. The one or more one-piece ceramic zirconia dental implants are properly placed using a surgical guide.

In yet another embodiment, the temporary restoration is fabricated as a U-shaped piece.

In an aspect, a full-mouth zirconia implant system for full mouth reconstruction using one or more one-piece ceramic zirconia dental implants, is disclosed. The full-mouth zirconia implant system is configured to acquire one or more analog impressions and one or more digital impressions of one or more tooth of one or more patients. The full-mouth zirconia implant system is further configured to fabricate a temporary restoration based on at least one of: the acquired one or more analog impressions and the acquired one or more digital impressions. The full-mouth zirconia implant system is further configured to adapt one or more medical professionals for administering anesthesia to the one or more patients.

The full-mouth zirconia implant system is further configured to create one or more vertical incision lines before Mucocutaneous Junctions (MC) s) on a face of the one or more patients. The full-mouth zirconia implant system is further configured to place the one or more one-piece ceramic zirconia dental implants in a jaw of the one or more patients. The full-mouth zirconia implant system is further configured to prepare at least four unextracted tooth for anchoring the temporary restoration. suture gum tissue around the one or more one-piece ceramic zirconia dental implants and at least four unextracted tooth, for optimizing an amount of keratinized tissue around the one or more one-piece ceramic zirconia dental implants.

The full-mouth zirconia implant system is further configured to anchor and seat the temporary restoration on the at least four unextracted tooth for avoiding premature contact with one or more abutments of the one or more one-piece ceramic zirconia dental implants. The full-mouth zirconia implant system is further configured to perform suturing around the temporary restoration to support optimized gum healing and shaping around the temporary restoration. The full-mouth zirconia implant system is further configured to utilize a cement for the temporary restoration for providing stability during a healing period. The full-mouth zirconia implant system is further configured to perform post-operative care. The post-operative care involves employing one or more hygiene protocols including antibacterial mouth rinses, warm salt water, and a waterpik, on the temporary restoration to prevent infections. The full-mouth zirconia implant system is further configured to initiate a prosthodontic phase after the healing period upon performing the post-operative care. The full-mouth zirconia implant system is further configured to assess smile of the one or more patients to determine whether an occlusal plane is parallel to a line connecting a tragus of an ear to an ala of the nose of the one or more patients. The full-mouth zirconia implant system is further configured to place a final restoration for the full mouth reconstruction.

In addition to the above, the process begins with bone augmentation, adding a bone in areas of the mouth where the bone is deficient. Once the bone is prepared, each missing tooth receives the one or more one-piece ceramic zirconia dental implants and crowns. The process aims to create a new mouth for patients, providing one of a fresh start and a second chance without the need for significant bone reduction. The one or more one-piece ceramic zirconia dental implants is biocompatible and corrode-resistant. The one or more one-piece ceramic zirconia dental implants do not show the gray hue around the gums, since the one or more one-piece ceramic zirconia dental implants is white in color. The one or more one-piece ceramic zirconia dental implants stand out as an outstanding choice since the one or more one-piece dental implants is not metal, making the one or more one-piece ceramic zirconia dental implants a safe alternative for the one or more patients who possess allergies to the metals.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 illustrates an exemplary first visual representation depicting a removable denture, in accordance with an embodiment of the prior art;

FIG. 2 illustrates an exemplary second visual representation depicting a hybrid denture, in accordance with an embodiment of the prior art;

FIG. 3A illustrates an exemplary front view of one or more one-piece ceramic zirconia dental implants, in accordance with an embodiment of the present disclosure;

FIG. 3B illustrates an exemplary top view of the one or more one-piece ceramic zirconia dental implants, in accordance with an embodiment of the present disclosure;

FIG. 3C illustrates an exemplary computed tomography (CT) scan view of a mouth reconstruction using the one or more one-piece ceramic zirconia dental implants, in accordance with an embodiment of the present disclosure;

FIG. 3D illustrates an exemplary third visual representation depicting a placement of the one or more one-piece ceramic zirconia dental implants, in accordance with an embodiment of the present disclosure; and

FIG. 4 illustrates a flow chart depicting a full-mouth zirconia implant method with a unique process for the mouth reconstruction using the one or more one-piece ceramic zirconia dental implants, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

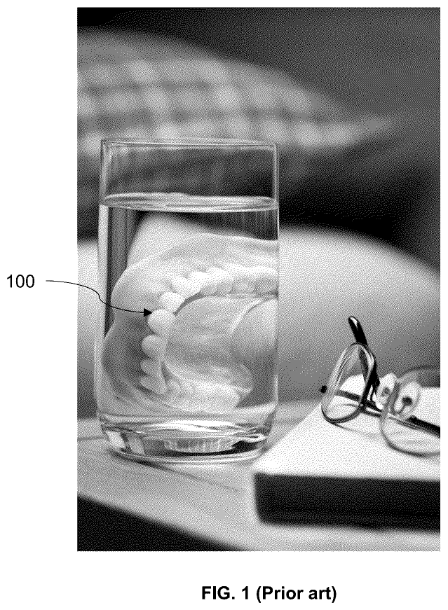

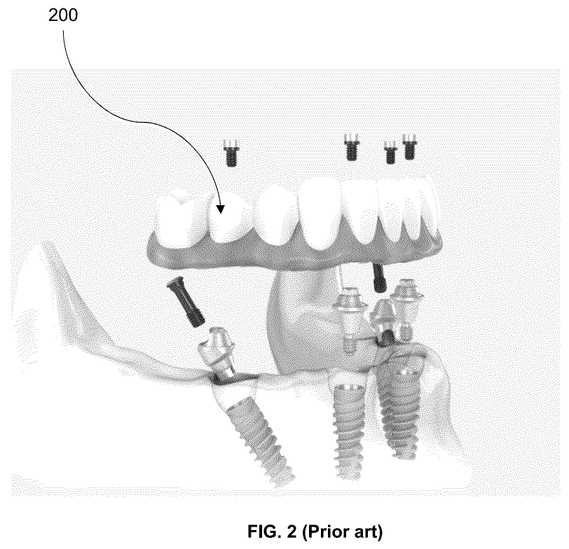

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

Embodiments of the present disclosure relate to a process, full-mouth zirconia implant system and method, for mouth reconstruction using one or more one-piece ceramic zirconia dental implants 300, thereby replacing missing teeth and restoring oral health, function, aesthetics, and confidence in the patients. The process for mouth reconstruction using one or more one-piece ceramic zirconia dental implants is also referred to as “All On Z One Piece Technique”.

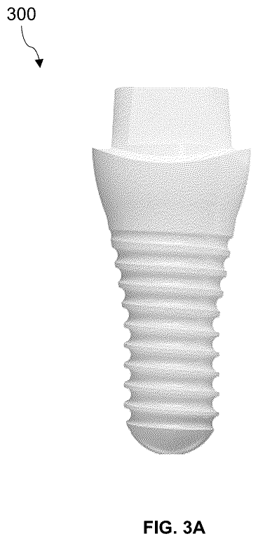

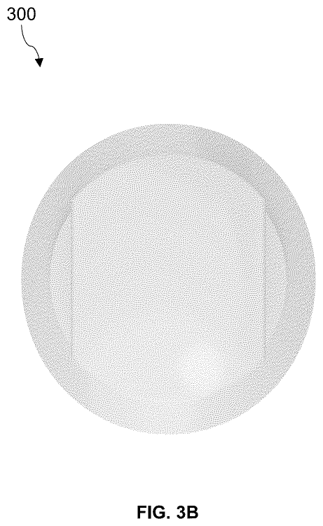

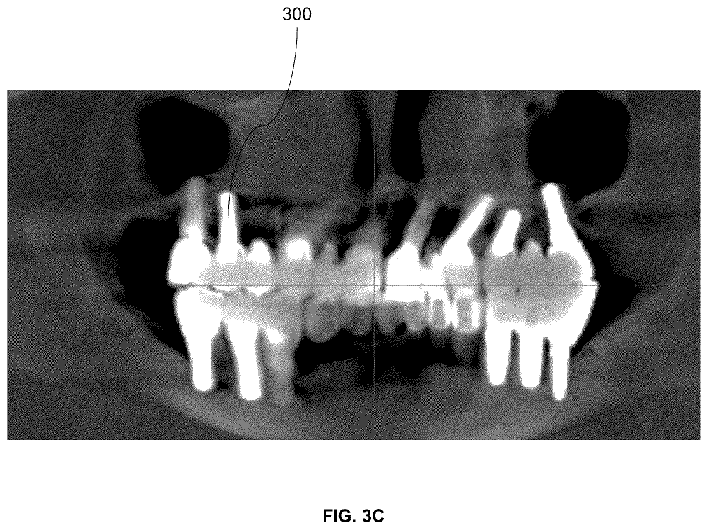

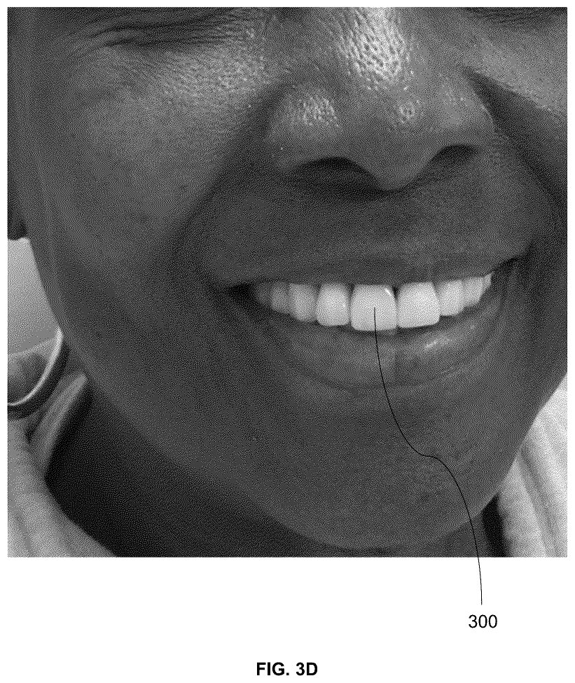

FIG. 3A illustrates an exemplary front view of the one or more one-piece ceramic zirconia dental implants 300, in accordance with an embodiment of the present disclosure;

FIG. 3B illustrates an exemplary top view of the one or more one-piece ceramic zirconia dental implants 300, in accordance with an embodiment of the present disclosure;

FIG. 3C illustrates an exemplary computed tomography (CT) scan view of a mouth reconstruction using the one or more one-piece ceramic zirconia dental implants 300, in accordance with an embodiment of the present disclosure; and

FIG. 3D illustrates an exemplary third visual representation depicting a placement of the one or more one-piece ceramic zirconia dental implants 300, in accordance with an embodiment of the present disclosure.

According to an exemplary embodiment of the disclosure, the full-mouth zirconia implant system performing a unique process for the mouth reconstruction using the one or more one-piece ceramic zirconia dental implants 300, is disclosed. The one or more one-piece ceramic zirconia dental implants 300 are a comprehensive and integrated solution for tooth replacement in dentistry. The one-piece design combines an implant and an abutment into a single unit, streamlining the placement process. The monolithic structure of the one or more one-piece ceramic zirconia dental implants 300, made of a zirconia, ensures durability, resistance to fractures, and an aesthetically pleasing appearance. The one or more one-piece ceramic zirconia dental implants 300 provide advantages including reduced treatment time, simplified surgical procedures, and an efficient approach to achieving both functional and cosmetic outcomes. The one-piece design eliminates the need for the separate abutment, contributing to enhanced biomechanical stability and overall implant success. The one or more one-piece ceramic zirconia dental implants 300 are biocompatible and resemble natural teeth, thereby the one or more one-piece ceramic zirconia dental implants 300 become a noteworthy option, particularly for patients seeking a reliable and convenient solution for the mouth restoration.

In an exemplary embodiment, a prerequisite to every full mouth reconstruction surgery involves undertaking presurgical steps to create the optimal conditions for a successful and precise procedure. Firstly, begin with studying the thorough medical history of the patients (i.e., one or more patients) to rule out any contraindications that may require adjustments in medications including sleep apnea, acid reflux, diabetes, A1C level, blood pressure medications, and the like. Further, a cone beam computed tomography (CBCT) is performed, thereby allowing for precise planning of the one or more one-piece ceramic zirconia dental implants 300 placement by providing detailed information about jawbone structure, nerves, adjacent teeth, and the like. The CBCT comprises several views including, but not limited to, coronal view, sagittal view, axial view, panoramic view, implant view, and the like.

The coronal view refers to an imaging perspective that provides views depicting, nasomeatal complex, osteoid patency, ethmoid, frontal, maxillary sinuses, sinuses congestion, nasal septum deviation, maxillary bone, mandibular bone, and the like. The sagittal view refers to the imaging perspective that provides the views depicting, sphenoid sinus, cella turcica, any calcifications, alveolar bone, teeth, temporomandibular joint (TMJ) complex, pneumatization of maxillary sinus floor, articular eminence, angle of the articular eminence slope in connection with anterior guidance, inferior alveolar (IA) nerve as the IA nerve travels through a mandibular canal in a bone, mental foramen, incisive nerve, nutritional canals, and the like. The axial view refers to the imaging perspective that provides the views depicting, head of condyles, the number of canals per tooth, pterygoid plates, and the like. The panoramic view refers to the imaging perspective that provides the views depicting general impressions, missing teeth, endodontically treated teeth, heights of the alveolar bone, and the like. The implant view refers to the imaging perspective that provides the views depicting a closer study of the IA nerve, thickness of the alveolar bone under the sinus, and density of the bone measured in Hounsfield units (HU).

Further, a clinical exam is performed comprising an extra oral that refers to areas outside an oral cavity. This part of the clinical exam, E.O, includes examining posture forward head posture, scoliosis, lordosis-palpation of masticatory muscles-masseters, temporalis, anterior belly of digastric and sizes of the anterior belly of digastric is normal, hypotrophy or hypertrophy is one of normal and same for both sides of one of the body and different, facial asymmetry, maximum opening, the TMJ popping and clicking, any deviation upon opening and closing the mouth, lip height, the amount of maxillary incisors are displayed in a repose and in a laugh, global diagnosis format, mallampati classification, skeletal classification, excessive premaxillary vertical growth, gummy smile, global diagnosis format, intraoral, and the like.

Further, an intra-oral examination is performed. The intra-oral examination includes examining of tonsils, lingually inclined mandibular molar, scalloped tongue, mandibular tori-buttressing bone, abfraction lesion, wear pattern, surface of the tongue, papillae, angles occlusal classification, lingual tie, minimum, moderate, excessively restored mouth, vaulted palate, mouth breather, document the teeth and caries, fractured restorations, and the like.

Further, a complete periodontal exam is performed. The complete periodontal exam includes examining a perio probing, mucogingival junction (MG)), clinical attachment loss (CAL), mobility, furcation, bleeding on probing, tissue phenotype one of thin and thick, soft tissue defects, recession due to toothbrush abrasions, the abfraction lesions due to occlusal interferences, aberrant frenal attachments, recession, the presence or lack of a keratinized tissue, according to a recent classification assess the periodontitis, halitosis, and the like, and come up with a diagnosis.

Further, an endodontic evaluation is performed. The endodontic evaluation includes examining which teeth are root canaled, failed root canals, root canals without full coverage, and the like. Further orthodontic exam is performed. The orthodontic exam includes examining angel classification, bicuspid extraction, crowding, and the like. Further esthetic exams are performed. The esthetic exams include the examination of a lip line, an active lip muscle, the amount of upper anterior teeth displayed in the repose, the amount of lower teeth displayed, and the amount of a gum displayed during the regular smile and during laughing.

Based on subjective information that was communicated by the patient directly and

the objective data that were gathered, an assessment or the diagnosis is reached. The assessment includes the diagnosis of the periodontal conditions, the diagnosis of the endodontic conditions, a global diagnosis, and perhaps one of a combination-Kelly's syndrome. If collectively, all the assessments lead to the comprehensive diagnosis of terminal dentition, then a treatment plan is formulated and presented to the patient. In addition, the alternatives, and each procedure's risks are thoroughly explained to the patient. If the patient chooses the full mouth reconstruction on the one or more one-piece ceramic zirconia dental implants 300, then the informed consents are signed. All the patient questions are answered and documented.

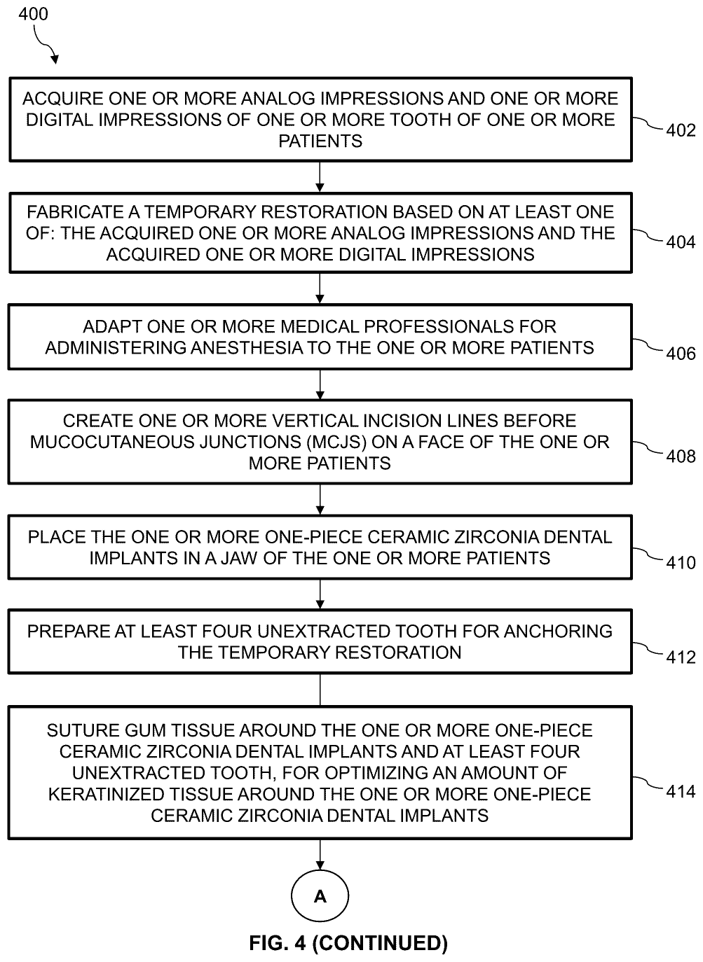

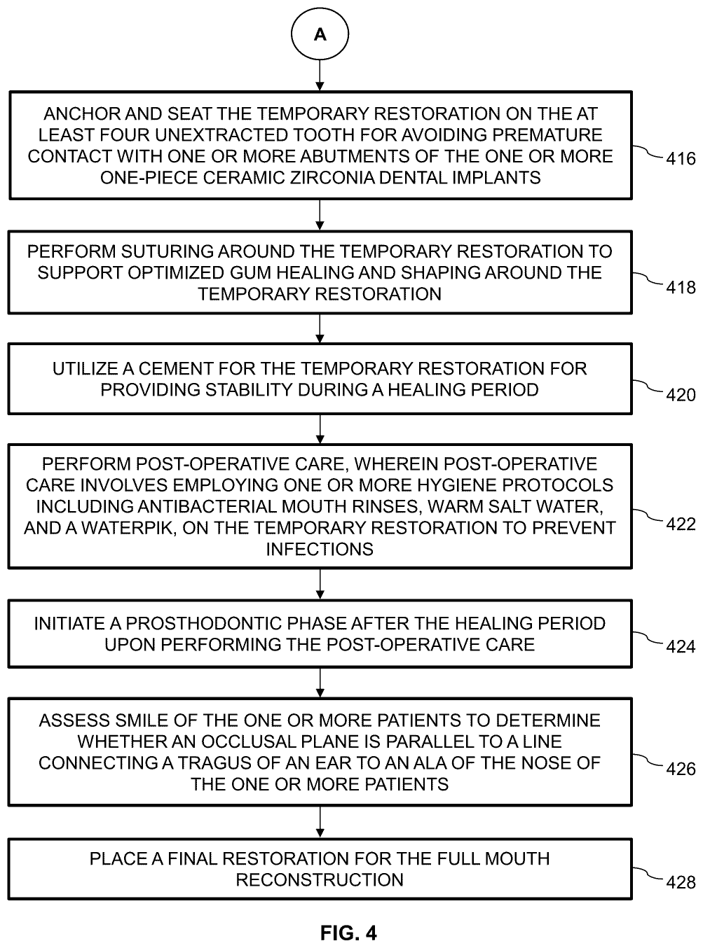

FIG. 4 illustrates a flow chart depicting the full-mouth zirconia implant method with the unique process 400 for the mouth reconstruction using the one or more one-piece ceramic zirconia dental implants 300, in accordance with an embodiment of the present disclosure.

In an exemplary embodiment, at step 402, the full-mouth zirconia implant method with the process 400 includes acquiring one or more analog impressions and one or more digital impressions of the teeth, followed by a creation of the cast and an articulated model using a face bow transfer. In the Standard Tessellation Language (STL) files, the same teeth are virtually extracted, and four unextracted teeth including canines and second molars remain for a virtual preparation. At step 404, the full-mouth zirconia implant method with the process 400 includes the fabrication of the temporary one-piece restoration on the analog model. The one-piece is designed to be seated and anchored by the remaining four unextracted teeth including the canines and the second molars. The step 404 further includes the fabrication and printing of the digital temporary. This gives a second set of the temporaries. The purpose of the temporaries (i.e., temporary restoration) which are anchored on the four unextracted teeth is to prevent the one or more one-piece ceramic zirconia dental implants 300 from occluding during the healing phase. The abutments of the one or more one-piece ceramic zirconia dental implants 300 are shorter in height than the U-shaped one-piece temporary. During the healing phase, the temporary restorations are anchored by the four unextracted teeth, ensuring that the one or more one-piece ceramic zirconia dental implants 300 avoid occlusion.

On the day of the surgery, the patient is prepared, and premedicated with prophylactic antibiotics. Depending on what the patient chooses, minimal oral sedation, IV, or general anesthesia is administered. The vital signs are taken to establish a baseline, and then the patient is connected to an electrocardiogram (EKG) machine, including blood pressure cuffs the blood pressure is constantly monitored and it performs a new reading every 15 minutes which is recorded to be printed at the end of the surgery. An oxygen uptake is measured with an oximeter, and carbon dioxide (CO2) exhale is measured with a capnometer.

At step 406, the full-mouth zirconia implant method with the process 400 includes adapting one or more medical professionals for administering anesthesia to the patient. Both left and right posterior superior alveolar, middle superior alveolar, anterior superior alveolar, and left and right greater palatine, and incisive palatine nerves are anesthetized. At step 408, the full-mouth zirconia implant method with the process 400 includes a number 15 blade to make three vertical incision lines just before the MCJ s on the facial. The first incision is distal of the most posterior tooth on each side and the third vertical is in the midline. Then connect the vertical incision lines by sulcular incisions across. Then employ a periosteal elevator and reflect a full mucoperiosteal flap. With the back of the periosteal elevator, a zygomatic process of the maxillary bone is exposed posteriorly. Anteriorly, the flap is reflected to expose the naso spine of the nasal bone. Extreme care is taken to avoid infra-orbital foramen. Further, the bone is decorticated and rinsed with a saline. Next with the number 15 blade make the short vertical incision palatally, do not cut the greater palatine nerve and the artery. The cut is made in the left and right, then with a number 12 blade do the sulcular incisions and connect the two vertical incisions.

Extract each tooth, excavate granulation tissues, scrape walls of the sockets, rinse with a saline solution, and add vitamin D3 powder inside each socket, followed by the immediate placement of the one or more one-piece ceramic zirconia dental implants 300. At step 410, the full-mouth zirconia implant method with the process 400 includes an immediate one or more one-piece ceramic zirconia dental implants 300 placement. The one or more one-piece ceramic zirconia dental implants 300 is longer than a length of the root and wider than a diameter of the root within the anatomical limitations. Further, the basal bone is engaged if possible. In the posterior teeth, use interradicular septal bone. In the anterior, utilize a Lindemann burr and create a new apex lingually, keeping in mind that there is a need for 2 mm of the facial bone to create osteotomy lingually and fill the gap between the facial threads of the one or more one-piece ceramic zirconia dental implants 300 and the lingual aspect of the facial bone with a bone graft. A mixture of the autogenous bone and a Platelet-Rich Plasma (PRP), thereby draping a membrane over the abutment securing and tucking the abutment under the lingual flap and the facial flap. Ensure that the one or more one-piece ceramic zirconia dental implants 300 placement adheres to anatomical limitations set by implantology guidelines.

At step 412, the full-mouth zirconia implant method with the process 400 includes preparation of the four unextracted teeth (i.e., at least four unextracted tooth). The four unextracted teeth are prepared in the mouth, similar to the steps taken on the articulated model and in the digital STL files. The first step endodontic is performed to make the access opening ⅔ of a bucco lingual width of the teeth. The one or more one-piece ceramic zirconia dental implants 300 are all placed, and optimal torques of 35-40 Nom of the one or more one-piece ceramic zirconia dental implants 300 are achieved with a hand ratchet. Moreover, the bone grafts, autogenous bone shavings are added in any openings in the sockets, and the membrane is draped over, make a cut on top of it to expose only the abutment of the one or more one-piece ceramic zirconia dental implants 300 protecting the bone graft underneath to exclude any epithelial and connective tissue growth,

At step 414, the full-mouth zirconia implant method with the process 400 includes suturing the gums around the one or more one-piece ceramic zirconia dental implants 300 and at least four unextracted tooth, for optimizing an amount of keratinized tissue around the one or more one-piece ceramic zirconia dental implants 300. Employment of two suture materials including a reverse cutting ⅜ and ½, monofilament non-resorbable size six, and a reverse cutting ⅜ non-resorbable monofilament vicryl size four. The goal is to maximize the amount of the keratinized tissue around the one or more one-piece ceramic zirconia dental implants 300. A pedicle and rolled flaps are employed in a suturing phase. Further, a periosteum is released to be able to achieve primary closure for an uneventful wound healing. Then carefully employ the back of the periosteal elevator and expand gently and coronally, once the expansion is achieved then employ the monofilament non-resorbable size six. Then the lingual and the facial flaps initially, a horizontal mattress for stability of the membrane, around each one-piece ceramic zirconia dental implant 300.

At step 416, the full-mouth zirconia implant method with the process 400 includes anchoring and seating of the temporaries restoration on the at least four unextracted tooth for avoiding premature contact with one or more abutments of the one or more one-piece ceramic zirconia dental implants 300. This approach avoids premature contact with the abutments of the one-piece ceramic zirconia dental implants 300 during the healing phase. The difference in height between the abutments of the one or more one-piece ceramic zirconia dental implants 300 is shorter and the un-extracted teeth are taller, thereby shielding the one or more one-piece ceramic zirconia dental implants 300 from the biting forces.

At step 418, the full-mouth zirconia implant method with the process 400 includes performing suturing around the temporary restoration to support optimized gum healing and shaping around the temporary restoration. Ensure that the suturing is done carefully to promote the proper healing and contouring of the gums around the temporary restoration. Then the single interrupted suture monofilament is used to approximate the incision lines ensuring a tension free closure. This results in healing by primary intention. With a finger rolling pressure, the palatal soft tissue is pressed on the bone, to eliminate possible air space between the flap and the bone. This will promote faster healing, and better attachment.

Further, monitor any signs of infection and complications during the initial healing period. At step 420, the full-mouth zirconia implant method with the process 400 includes the cementation of the temporary restoration. Employing a permanent cement for the temporary restoration may provide stability during the healing period. Always confirm that the temporary restoration is configured with the desired oval shape and hygienic contour under the pontic area which is on top of the abutments. No residual cement must be left anywhere.

At step 422, the full-mouth zirconia implant method with the process 400 includes a post-operative care. Emphasizing strict hygiene protocols, including the employment of the antibacterial mouth rinses, warm salt water, and a waterpik, on the temporary restoration to prevent infections and to promote healing. The post-operative care further ensures that the patient's vit D3 is appropriate pre-surgery and post-surgery.

At step 424, the full-mouth zirconia implant method with the process 400 includes the beginning of a prosthodontic phase after the healing period upon performing the post-operative care. The prosthodontic phase is discussed in-depth in further

embodiments of the disclosure (as disclosed in paragraph [0077]). The following parameters must be evaluated because the parameters are critical for the proper diagnosis and treatment planning. The parameters are considered sequentially. The parameters may include at least one of: A-Maxillary anterior tooth position, B-Mandibular anterior tooth position, C-Occlusal plane, D-Vertical dimension of occlusion, and E-Occlusal scheme. The parameters are critical to treatment planning for full arch cases.

At step 426, the full-mouth zirconia implant method with the process 400 includes assessing the smile of the patients, ensuring the occlusal plane is parallel to the line connecting the tragus of the ear to the ala of the nose. Evaluate the incisal edges of the lower and draw a line posteriorly to the distal of the last molar tooth and envision it to meet the retromolar pad ⅔ up, upper centrals in relation to the imaginary interpupillary line and making sure they are parallel, Then with a marker, a dot is placed on the nose and another dot on the chin, the patient is asked to bite on back teeth, measure the distance between the two dots. Then ask the patient to say “EMMA” and then swallow followed by relaxation. Here, the patient is relaxed, and the patient is not biting, totally relaxed mandible. Now, measure the distance between the two dots again. Subtract the first measurement from the second measurement. This is a physiologic space of the patient. Here it can be determined, if the patient is configured with a collapsed bite, evaluate the naso labial folds, cheloisis of the lips. Now evaluate the profile, at the patient sideways, for the position of the incisal edge of the upper teeth behind the line that connects the tip of the nose to the chin. Test phonetics of the patient on the temporaries, focusing on sounds like S, V, and M. Ensure that the temporaries are designed to accommodate proper speech. Capture a photo and video of the patient with the temporary. Take the digital impressions of both the upper jaw and the lower jaw. Record the bite of the patient while completely clenched.

All the adjustments are done on the temporaries (before the temporaries removal from the patient). Once all the criteria are met, functionally, esthetically, and phonetically, the occlusion is established as a mutually protected occlusion, This will be the blueprint of the final restoration. Therefore, a digital impression is taken prior to the temporary removal, followed by scanning the lower jaw and scanning the bite that is the patient is biting on the back teeth. As originally planned, remove the second molars and the premolars and place the one or more one-piece ceramic zirconia dental implants 300 with a slightly wider diameter in place of the canines. Aim for a 40 Newton per centimeter force, indicating the potential for immediate, The one or more one-piece ceramic zirconia dental implants 300 are prepped just like natural teeth, modifications are made on the one or more one-piece ceramic zirconia dental implants 300. Then with the intra oral scan the digital impressions of the ceramic abutments are taken. The next appointment, at step 428, the full-mouth zirconia implant method with the process 400 includes delivering the final restoration, and cementing. The excess cement is removed. The same process may be applied to a lower jaw of the one or more patients.

In an exemplary embodiment, after the completion of the upper jaw, the patient comes back for the bottom teeth. The patient possesses the upper restorations already. A scan of the new upper teeth, a scan of the lower teeth, and a scan of the upper and lower teeth biting together is taken. In the computer, the lower teeth are extracted virtually minus the canines to anchor the future temporary. A tooth supported temporary is designed and printed. Then the surgery of the lower jaw is initiated using the same principles as the upper jaw. The differences in the surgical preparation for the lower jawbone are described as follows. Block anesthesia is administered bilaterally. A full mucoperiosteal flap is reflected facially, by first cutting the vertical incision lines distal to the last molars bilaterally, then sulcular/crestal incisions connecting the two vertical incision lines. Extreme care is taken to avoid the mental nerve exiting the mental foramen. Then slight lingual reflection is done to reflect the lingual flap. Consider the attachment of the mylohyoid muscle lingually. All the teeth are removed except the canines and the second molars. The first step of the endodontic exam is performed on the four unextracted teeth. The surgical guide is placed over the four unextracted teeth. The pilot drill and the first twist drill in the osteotomy are used. Then the surgical guide is removed, and the one or more one-piece ceramic zirconia dental implants 300 are placed. The temporary is removed, and the prefabricated temporary is placed on the four unextracted teeth higher than the abutments of the one or more one-piece ceramic zirconia dental implants 300.

In an exemplary embodiment, several classifications are characterized based on the full mouth restoration. The classifications include classification A, classification B, classification C, classification D, classification E, classification F, classification G, classification H, classification I, classification J, classification K, and classification L. The classification A is a condition of the patient where all upper teeth need to be removed, the patient is periodontally resistant, and the lower teeth are intact. The classification A includes the following surgical steps including stage 1 and stage 2 are described further. In stage 1, the full mucoperiosteal flap is elevated from the distal of the last molar on the right to the distal of the first molar on the left both facially and palatally. All the teeth except the four unextracted teeth are extracted atraumatically, leaving bone intact facially, and interdentally in the septal and also the palatally. The walls of the extraction sockets, and the facial bone are degranulated, to remove all the granulation tissue and decorticate.

The one or more one-piece ceramic zirconia dental implants 300 are placed in each extraction site deeper than the original root of the teeth to achieve a strong torque. The empty gaps between the body of the one or more one-piece ceramic zirconia dental implants 300, the threads of the one or more one-piece ceramic zirconia dental implants 300, and the bone are filled with the bone graft. Preferably the canines and then one of the first and second molars. Now the four unextracted teeth that were left, have pulpectomies done and prep. A pedicle graft is performed around each one or more one-piece ceramic zirconia dental implants 300 to gain the thicker keratinized tissue. The entire flap is placed tightly back on the bone and sutured. The temporary is already made in advance and is placed onto the four unextracted teeth. The temporary protects the abutment of the one or more one-piece ceramic zirconia dental implants 300 during the healing phase. The temporary provides the patient with transitional teeth and gives the patient an opportunity for trial, both esthetically and phonetically. Further, in the stage 2, the four unextracted teeth that are kept anchoring temporarily, are removed. Only the canines are implanted, with the one or more one-piece ceramic zirconia dental implants 300 possible to get the strong torque. The other two teeth do not need to receive the one or more one-piece ceramic zirconia dental implants 300. Further, the beginning of the prosthodontic phase takes place. The prosthodontic phase is discussed in-depth in further embodiments of the disclosure (as disclosed in paragraph [0077]).

In an exemplary embodiment, classification B is a condition of the patient where the upper teeth of the patient have recently been removed, the patient is configured with an immediate upper denture, and the lower teeth are intact. The classification B includes the following surgical steps. The surgical steps include exposing an entire palatal bone. The bony-supported surgical guide is secured on the palate with fixation screws. In the next step, the pilot burrs are used to create osteotomies, then the surgical guide is removed, and the one or more one-piece ceramic zirconia dental implants 300 are placed in the osteotomies. In the next step, the prefabricated temporary is placed on the one or more one-piece ceramic zirconia dental implants 300. Further, 10 one-piece dental implants 300 that do not violate the anatomical landmarks are chosen for the upper jaw, Therefore, five one-piece dental implants 300 in each quadrant in a key position as also planned in the surgical guide. Preferably in the teeth number 8,9,7,10,6,11,4,13,2,15. If the sinuses are pneumatized, the position of the molars is grafted. Then the second stage is needed to add the one or more one-piece ceramic zirconia dental implants 300 to the grafted sites. Further, the beginning of the prosthodontic phase takes place. The prosthodontic phase is discussed in-depth in further embodiments of the disclosure (as disclosed in paragraph [0077]).

In an exemplary embodiment, the classification C is a condition of the patient where there is an adequate amount of bone in the anterior zone from the canine to the canine. There is insufficient vertical bone posteriorly, both the sinuses are pneumatized, and the lower teeth are intact. The classification C includes the following surgical steps including stage 1 and stage 2. In stage 1, the bilateral sinus lifts, and the bone grafts through a lateral window. Then place the one or more one-piece ceramic zirconia dental implants 300 anteriorly every 3-mm apart as planned through the surgical guide. After 6 months, in stage 2, place the two one-piece dental implants 300 posteriorly on each side. After 3 months, the beginning of the prosthodontic phase takes place. The prosthodontic phase is discussed in-depth in further embodiments of the disclosure (as disclosed in paragraph [0077]).

In an exemplary embodiment, the classification D is a condition of the patient where there is adequate bone posteriorly on both sides, but insufficient vertical and horizontal bone anteriorly, and the lower teeth are intact. The classification D includes the following surgical steps including stage 1 and stage 2. In stage 1, free a gingival graft to increase the height of the anterior ridge gingiva, which is a ridge graft, and to prepare for the bone grafting. Place the three one-piece dental implants 300 on each side bilaterally and posteriorly. Empty the contents of the incisive papillary canal and add the bone graft. Place the mini-implants and create the temporary supported by one of the mini-implants and add the one or more one-piece ceramic zirconia dental implants 300 to support the temporary.

In stage 2, the ridge is split in the center then the four one-piece dental implants 300 are placed engaging the basal bone. In the anterior, very close to the basal bone of the nose. Here the one-piece dental implant 300 threads are employed as tenting screws. The bio oss collagen is embedded with the autogenous bones and prp and around each one-piece dental implant 300. The sticky bone is made and it is wrapped around each one-piece dental implant 300 followed by guided tissue regeneration (GTR) and sutured. The denture is relined again but the denture must not touch the anterior implants so meanwhile one may place the mini-implants in a nasopalatine canal. Further, the beginning of the prosthodontic phase takes place. The prosthodontic phase is discussed in-depth in further embodiments of the disclosure (as disclosed in paragraph [0077]).

In an exemplary embodiment, the classification E is a condition of the patient where there is the adequate bone in the anterior and posterior one of the left and right, the sinus is pneumatized on the side that is configured with a vertical deficiency, and the lower teeth are intact. The classification E includes the following surgical steps including stage 1 and stage 2. In stage 1, a vertical bone augmentation sinus is lifted, and the bone graft is added to augment the ridge vertically. Then place the one or more one-piece ceramic zirconia dental implants 300 elsewhere, using the surgical guide. Seat the prefabricated temporary. Further, After 6 months, in the stage 2, add the one or more one-piece ceramic zirconia dental implants 300 to the side of the grafted bone. After 3 months, the beginning of the prosthodontic phase takes place. The prosthodontic phase is discussed in-depth in further embodiments of the disclosure (as disclosed in paragraph [0077]).

In an exemplary embodiment, the classification F is a condition where the bone of the patient is missing in both the anteriorly and posteriorly. The classification F includes the following surgical steps including stage 1 and stage 2. In stage 1, the bilateral sinus is lifted. Place the one or more one-piece ceramic zirconia dental implants 300. In stage 2, fabricate a polyetheretherketone (PEEK) appliance with composite teeth inside. Cement the PEEK onto the abutments of the one or more one-piece ceramic zirconia dental implants 300. Further, there is no option except to give the patient an FP3 restoration. The FP3 restoration is given if the patient presents with no bone in the first place, the bone is severely compromised, and adding the bone is an unpredictable treatment. The FP3 restoration begins with the first surgery followed by the second surgery. The first surgery includes the lifting of the bilateral sinus and the bone graft, splitting the ridge, and adding the one or more one-piece ceramic zirconia dental implants 300 anteriorly.

The second surgery includes adding the one or more one-piece ceramic zirconia dental implants 300 posteriorly into the sinus areas, three months later restoring all the one or more one-piece ceramic zirconia dental implants 300, then the PEEK is employed and is seated onto the one-piece dental implants 300, composite teeth are placed into the peek base, the PEEK base is cemented onto the one or more one-piece ceramic zirconia dental implants 300. A modification of this exists, the patient in some areas is FP1, and in other areas FP3. A pink composite is added to the FP3 to match the FP1. The FP1 is a condition where only the teeth of the patient are being replaced. Further, the beginning of the prosthodontic phase takes place. The prosthodontic phase is discussed in-depth in further embodiments of the disclosure (as disclosed in paragraph [0077]).

In an exemplary embodiment, the classification G is a condition where the upper teeth are intact, and all the lower teeth need to be removed. Therefore, there is a need for the immediate one-piece dental implant 300 just like classification A. Then depending on the location of the inferior alveolar nerve, if the safety zone is met, then the immediate one or more one-piece ceramic zirconia dental implants 300 are placed. The classification G includes the following surgical steps, stage 1. In stage 1, first, remove all the teeth except the second molars and the few incisors anteriorly including 23 and 26. Then remove all teeth atraumatically. Further, place the surgical guide using the second molars, 23, and 26. Then use the pilot drills and do the osteotomies. Then remove the surgical guide. Followed by placing the one or more one-piece ceramic zirconia dental implants 300 as planned. Place the temporary, which is anchored by the second molars, 23, and 26. The temporary is higher than the abutment of the one or more one-piece ceramic zirconia dental implants 300. Further, the beginning of the prosthodontic phase takes place. The prosthodontic phase is discussed in-depth in further embodiments of the disclosure (as disclosed in paragraph [0077]).

In an exemplary embodiment, the classification H is a condition where the upper teeth are intact, and all the teeth of the patient are removed. Henceforth, the patient has an immediate denture. There is still an adequate amount of bone and also, there is adequate space between the apices of the molar teeth and the inferior alveolar nerve. Using the surgical guide, the one or more one-piece ceramic zirconia dental implants 300 are placed in key positions. The temporary is then placed over the one or more one-piece ceramic zirconia dental implants 300. Further, the beginning of the prosthodontic phase takes place. The prosthodontic phase is discussed in-depth in further embodiments of the disclosure (as disclosed in paragraph [0077]).

In an exemplary embodiment, the classification I is a condition where the upper teeth are intact. The lower jaw is configured with the sufficient bone anteriorly but both the left and right bones are resorbed posteriorly. The classification I includes the following surgical steps such as stage 1. In stage 1, increase the height of the posterior by adding the ridge gum graft, and perform both the horizontal and vertical bone augmentation. Place the one or more one-piece ceramic zirconia dental implants 300 anteriorly, do not place any one-piece dental implant 300 posteriorly. Further, after 6 months, add the one or more one-piece ceramic zirconia dental implants 300 posteriorly. After 3 months, the beginning of the prosthodontic phase takes place. The prosthodontic phase is discussed in-depth

in further embodiments of the disclosure (as disclosed in paragraph [0077]). In an exemplary embodiment, the classification J is a condition where the upper teeth are intact. The lower jaw is configured with the sufficient bone posteriorly on both sides but resorbed ridge anteriorly. Utilizing the surgical guide, the one or more one-piece ceramic zirconia dental implants 300 are placed posteriorly. In the anterior region, perform a “purse” technique, and then the one or more one-piece ceramic zirconia dental implants 300 are placed. Then the threads of the one or more one-piece ceramic zirconia dental implants 300 are employed for the tenting screws, and the bone is added. Then the temporary is worn connecting all the one or more one-piece ceramic zirconia dental implants 300. Further, the beginning of the prosthodontic phase takes place. The prosthodontic phase is discussed in-depth in further embodiments of the disclosure (as disclosed in paragraph [0077]).

In an exemplary embodiment, the classification K is a condition where the upper teeth are intact, having sufficient bone anteriorly and posteriorly on one of the left and right, and the bone is deficient on one side. The classification K includes the following surgical steps such as stage 1, and stage 2. In stage 1, the palatal graft is added to the missing ridge. During stage 2, after 2 months, the one or more one-piece ceramic zirconia dental implants 300 are positioned with the aid of the surgical guide. In the site that is missing the bone height and width, the keratinized tissue is augmented both vertically and horizontally. After 6 months, a third surgery begins where the one or more one-piece ceramic zirconia dental implants 300 are placed in the augmented site. After 3 months, the beginning of the prosthodontic phase takes place. The prosthodontic phase is discussed in-depth in further embodiments of the disclosure (as disclosed in paragraph [0077]).

In an exemplary embodiment, presentations from the patients may include concerns and conditions in both the upper teeth and lower teeth. In such cases, combinations of classifications are considered. The combinations include six groups. The first group comprises the combined classifications of AG, AH, AI, AJ, and AK. The second group comprises the combined classifications of BG, BH, BI, BJ, and BK. The third group comprises the combined classifications of CG, CH, CI, CJ, and CK. The fourth group comprises the combined classifications of DG, DH, DI, DJ, and DK. The fifth group comprises the combined classifications of EG, EH, EI, EJ, and EK. The sixth group comprises the combined classifications of FG, FH, FI, FJ, and FK.

In an exemplary embodiment, the classification L is the worst scenario, a condition where the upper teeth and the lower teeth are configured with all the alveolar bone lost and only the basal bone is remaining. Therefore, the FP3 is a condition where the bone and the gum, If the patient is without the denture, then fabricate the denture. If the patient has the denture, then conduct the CBCT. Perform the CT scan without the denture. Then place radiopaque composites in the denture and take another CT scan with the denture. Further, perform the intraoral scan. Scan with and without the denture. Scan the upper teeth and the lower teeth separately and together with the denture. Scan the denture inside and outside. Merge the DICOM and STL files and create the surgical guide.

In the prosthodontic phase, the entire case that is mounted on an articulator and waxed up to mutually protected occlusion is used as a guide to fabricate the temporaries which are seated immediately post-surgery. By now, the patient is wearing the temporaries for a minimum of 4 months. A Periotest device is employed to check whether the one or more one-piece ceramic zirconia dental implants 300 are integrated solidly. The esthetics, the phonetics, and the occlusion are checked and approved by the patient and the doctor. Then the intraoral scans of the upper temporary, the lower temporary, and the upper and the lower teeth in maximum intercuspation are taken. Then the temporary is removed, and the four remaining teeth that anchored the temporaries during the healing phase, are removed. In the position of the two canines, the two one-piece dental implants 300 are used. A strong torque of 35 Ncm is desirable.

All the one or more one-piece ceramic zirconia dental implants 300 are prepped and sculpted. The margins are prepared and modified if needed. In case the two one-piece dental implants 300 were placed too close together during the healing time, they are prepared to create a 3 mm distance between them. By having the ends in mind, the one or more one-piece ceramic zirconia dental implants 300 are sculpted and prepared to receive the final teeth crowns onto the one or more one-piece ceramic zirconia dental implants 300. The use of the surgical guide minimizes this sculpting and the adjusting of the one or more one-piece ceramic zirconia dental implants 300. Then after the preparation is done, the final impression is taken from all the one or more one-piece ceramic zirconia dental implants 300. Further, the final impression is sent to the lab to construct all the ceramic crowns. The ceramic crowns are delivered and cemented. All the cement must be removed. All the restorations are hygienic. The intaglio surface is convex for self-cleansibility. The margins of the restorations are either at or slightly supragingival. The white of the ceramic implant, as opposed to a gray of titanium easily blends in with the restoration itself. In cases where the transition is noticeable, a class 5 prep is done at the margin and a composite is added to blend.

Traditionally, in the anterior maxilla, due to its slope, in case of two-piece dental implants either two-piece ceramic or two-piece titanium angled abutments are employed to overcome this curvature. On the other hand, the abutments of one or more one-piece ceramic zirconia dental implants 300 are sculpted to ensure a natural look and alignment with the adjacent natural teeth. This is done using zirconia cutting burs and copious amount of water to cool off the heat produced during the friction to prevent microfracture of the abutments made by the zirconia.

In the case of FP1, the only space requirement is the height of the missing tooth, and if there is not sufficient bone, then the bone is added to those areas. As each tooth is removed the one or more one-piece ceramic zirconia dental implants 300 is inserted. Normally, in each quadrant, if 5 teeth are removed and 4 one-piece dental implants 300 are inserted. Each jaw receives 8 to 10 one-piece dental implants 300. All on 6 or all on 8 or all on 10 one-piece dental implants 300 are completed with the placement of six, eight, or ten one-piece dental implants 300 in the bone. Then each one-piece dental implant 300 receives the crowns.

Modification of the split the ridge technique is also referred to as the purse technique. In the split the ridge technique, the areas where the bone is deficient horizontally, the ridge is splitted crestally. Two vertical cuts all the way going through the cortical bone and the cancellous bone are made facially on mesial and distal of the cut. Further, the purse technique is modified by adding another cut apical connecting the two vertical cuts. However, the vertical cut is different and only cuts half of the cortical thickness. Then the ridge is carefully splitted and is bending at the apical cut. Followed by a collagen membrane from the mesial of the mesial vertical incision and distal of the distal vertical incision. Then the membrane is tacked in place. Then the one or more one-piece ceramic zirconia dental implants 300 are placed into the splitted ridge. In the ridge itself bone shavings are placed. And on the facial side between the membrane and the facial bone, more autogenous cells are placed.

Further, a SGP process consists of the surgical guide and provisionals combined into one. The SGP is employed to do two functions at the same time. To be used as the surgical guide to place the one or more one-piece ceramic zirconia dental implants 300 and rests on the natural teeth and to act as the long-lasting provisional temporary. The SGP is employed for the immediate one or more one-piece ceramic zirconia dental implants 300 in a full-mouth zirconia implant system.

The surgical guide is used in advance, and the teeth on the cast are mounted and waxed up on the articulated model. A model of this wax up is taken. On the cast, osteotomies are made. Followed by placing flowable composites inside these canals. then on top of the teeth and the flowable composites a rope of composite is placed and connected to the flowable composite. Then the rope and the flowable composites are retrieved. So now osteotomy is done. Then drill inside the canals from the bottom to the top. The surgical guide that is employed as a canal in the four natural teeth (to be extracted later) and also the osteotomies are done. Henceforth, the temporaries and the surgical guide are in one piece.

Numerous advantages of the present disclosure may be apparent from the discussion above. In accordance with the present disclosure, the process for mouth reconstruction using the one-piece dental implants is provided. The one-piece dental implants are configured with the enhanced overall strength and stability of the prosthetic, making the one-piece dental implants a more robust solution for dental restoration by eliminating the interface between the abutment and the one-piece dental implant. The natural-looking aesthetics of the one-piece dental implants made from the zirconia is a significant advantage over traditional metal dental implants. The high-quality, 300% white color of the one-piece dental implants made from the zirconia and the abutment attached to the one-piece dental implants, blend seamlessly with the natural teeth. This feature provides excellent advantages in terms of appearance. The one-piece dental implants made from the zirconia are configured with no gray lines around the gum, unlike the traditional metal dental implants, which causes discoloration of the gum, leading to a fake appearance. Patient feedback and satisfaction also indicate that the one-piece dental implants made from the zirconia provide the desired aesthetics with close to zero postoperative discomfort.

The biocompatibility of the one or more one-piece ceramic zirconia dental implants 300 made from the zirconia makes them resistant to inflammation known to cause peri-implantitis which is seen around titanium dental implants. The one or more one-piece ceramic zirconia dental implants 300 made from the zirconia are ideal for those with sensitivities because they are metal-free. Metal sensitivities cause inflammation and allergic reactions. The one or more one-piece ceramic zirconia dental implants 300 made from the zirconia do not trigger any reaction. The dental implant success rate of the one or more one-piece ceramic zirconia dental implants 300 made from the zirconia is 99%, which is an added advantage for titanium-sensitive patients. The one or more one-piece ceramic zirconia dental implants 300 made from the zirconia are configured with the same if not higher strength than the traditional metal titanium dental implants. The one or more one-piece ceramic zirconia dental implants 300 made from the zirconia are configured with a high strength rating that supports the teeth replacement. This feature makes them ideal for patients who need teeth replacement. The tensile strength of the one or more one-piece ceramic zirconia dental implants 300 made from the zirconia is higher than the titanium dental implants. The process for mouth reconstruction using the one or more one-piece ceramic zirconia dental implants 300 is also referred to as “All On Z One Piece Technique”.

A description of an embodiment with several components in communication with each other does not imply that all such components are required. On the contrary, a variety of optional components are described to illustrate the wide variety of possible embodiments of the disclosure. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices that are not explicitly described as having such functionality/features. Thus, other embodiments of the disclosure need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

What is claimed is:

1. A full-mouth zirconia implant method for full mouth reconstruction using one or more one-piece ceramic zirconia dental implants, the full-mouth zirconia implant method comprising:
acquiring one or more analog impressions and one or more digital impressions of one or more tooth of one or more patients;
fabricating a temporary restoration based on at least one of: the acquired one or more analog impressions and the acquired one or more digital impressions;
adapting one or more medical professionals for administering anesthesia to the one or more patients;
creating one or more vertical incision lines before Mucocutaneous Junctions (MCJs) on a face of the one or more patients;
placing the one or more one-piece ceramic zirconia dental implants in a jaw of the one or more patients;
preparing at least four unextracted tooth for anchoring the temporary restoration;
suturing gum tissue around the one or more one-piece ceramic zirconia dental implants and at least four unextracted tooth, for optimizing an amount of keratinized tissue around the one or more one-piece ceramic zirconia dental implants;
anchoring and seating the temporary restoration on the at least four unextracted tooth for avoiding premature contact with one or more abutments of the one or more one-piece ceramic zirconia dental implants;
performing suturing around the temporary restoration to support optimized gum healing and shaping around the temporary restoration;
utilizing a cement for the temporary restoration for providing stability during a healing period;
performing post-operative care, wherein the post-operative care involves employing one or more hygiene protocols including antibacterial mouth rinses, warm salt water, and a waterpik, on the temporary restoration to prevent infections;
initiating a prosthodontic phase after the healing period upon performing the post-operative care;
assessing smile of the one or more patients to determine whether an occlusal plane is parallel to a line connecting a tragus of an ear to an ala of the nose of the one or more patients; and
placing a final restoration for the full mouth reconstruction.

2. The full-mouth zirconia implant method of claim 1, further comprising performing bone augmentation prior to placing the one or more one-piece ceramic zirconia dental implants.

3. The full-mouth zirconia implant method of claim 1, further comprising optimizing sculpting and preparing the one or more one-piece ceramic zirconia dental implants for adapting one or more ceramic crowns to be placed on the one or more one-piece ceramic zirconia dental implants.

4. The full-mouth zirconia implant method of claim 1, further comprising performing a ridge splitting technique to accommodate the one or more one-piece ceramic zirconia dental implants in areas of inadequate bone width.

5. The full-mouth zirconia implant method of claim 1, wherein initiating the prosthodontic phase after the healing period, comprises:
evaluating osseointegration of the one or more one-piece ceramic zirconia dental implants, after the healing period;
analyzing at least one of: aesthetics, phonetics, and occlusion, of the temporary restoration worn by the one or more patient during the healing period;
performing at least one of: intraoral scans of upper and lower temporary restorations, and one or more scans of upper and lower teeth in maximum intercuspation;
extracting the at least four unextracted tooth that anchored the temporary restoration during healing;
sculpting and modifying the one or more one-piece ceramic zirconia dental implants to create proper spacing, alignment, and margins, for the final restoration;
taking one or more impressions of the prepared one or more one-piece ceramic zirconia dental implants for fabrication of the final restoration;
constructing the one or more ceramic crowns based on at least one of: the one or more impressions and one or more digital scans; and
placing the one or more ceramic crowns onto the one or more one-piece ceramic zirconia dental implants.

6. The full-mouth zirconia implant method of claim 1, wherein placing the final restoration comprises arranging each ceramic crown of the one or more ceramic crowns for each of the one or more one-piece ceramic zirconia dental implants.

7. The full-mouth zirconia implant method of claim 1, wherein the one or more one-piece ceramic zirconia dental implants are placed immediately after tooth extraction.

8. The full-mouth zirconia implant method of claim 1, wherein the temporary restoration is configured to avoid occlusion with the one or more one-piece ceramic zirconia dental implants during the healing period.

9. The full-mouth zirconia implant method of claim 1, wherein the one or more one-piece ceramic zirconia dental implants are placed without significant bone reduction, and wherein the one or more one-piece ceramic zirconia dental implants are properly placed using a surgical guide.

10. The full-mouth zirconia implant method of claim 1, wherein the temporary restoration is fabricated as a U-shaped piece.

11. A full-mouth zirconia implant system for full mouth reconstruction using one or more one-piece ceramic zirconia dental implants, the full-mouth zirconia implant system is configured to:
acquire one or more analog impressions and one or more digital impressions of one or more tooth of one or more patients;
fabricate a temporary restoration based on at least one of: the acquired one or more analog impressions and the acquired one or more digital impressions;
adapt one or more medical professionals for administering anesthesia to the one or more patients;
create one or more vertical incision lines before Mucocutaneous Junctions (MCJ s) on a face of the one or more patients;
place the one or more one-piece ceramic zirconia dental implants in a jaw of the one or more patients;
prepare at least four unextracted tooth for anchoring the temporary restoration;
suture gum tissue around the one or more one-piece ceramic zirconia dental implants and at least four unextracted tooth, for optimizing an amount of keratinized tissue around the one or more one-piece ceramic zirconia dental implants;
anchor and seat the temporary restoration on the at least four unextracted tooth for avoiding premature contact with one or more abutments of the one or more one-piece ceramic zirconia dental implants;
perform suturing around the temporary restoration to support optimized gum healing and shaping around the temporary restoration;
utilize a cement for the temporary restoration for providing stability during a healing period;
perform post-operative care, wherein the post-operative care involves employing one or more hygiene protocols including antibacterial mouth rinses, warm salt water, and a waterpik, on the temporary restoration to prevent infections;
initiate a prosthodontic phase after the healing period upon performing the post-operative care;
assess smile of the one or more patients to determine whether an occlusal plane is parallel to a line connecting a tragus of an ear to an ala of the nose of the one or more patients; and
place a final restoration for the full mouth reconstruction.

12. The full-mouth zirconia implant system of claim 11, wherein the full-mouth zirconia implant system is further configured to perform bone augmentation prior to placing the one or more one-piece ceramic zirconia dental implants.

13. The full-mouth zirconia implant system of claim 11, wherein the full-mouth zirconia implant system is further configured to sculpt and prepare the one or more one-piece ceramic zirconia dental implants for adapting one or more ceramic crowns to be placed on the one or more one-piece ceramic zirconia dental implants.

14. The full-mouth zirconia implant system of claim 11, wherein the full-mouth zirconia implant system is configured to perform a ridge splitting technique to accommodate the one or more one-piece ceramic zirconia dental implants in areas of inadequate bone width.

15. The full-mouth zirconia implant system of claim 11, wherein in initiating the prosthodontic phase after the healing period, the full-mouth zirconia implant system is configured to:
evaluate osseointegration of the one or more one-piece ceramic zirconia dental implants, after the healing period;
analyze at least one of: aesthetics, phonetics, and occlusion, of the temporary restoration worn by the one or more patient during the healing period;
perform at least one of: intraoral scans of upper and lower temporary restorations, and one or more scans of upper and lower teeth in maximum intercuspation;
extract the at least four unextracted tooth that anchored the temporary restoration during healing;
sculpt and modifying the one or more one-piece ceramic zirconia dental implants to create proper spacing, alignment, and margins, for the final restoration;
take one or more impressions of the prepared one or more one-piece ceramic zirconia dental implants for fabrication of the final restoration;
construct the one or more ceramic crowns based on at least one of: the one or more impressions and one or more digital scans; and
place the one or more ceramic crowns onto the one or more one-piece ceramic zirconia dental implants.

16. The full-mouth zirconia implant system of claim 11, wherein in placing the final restoration, the full-mouth zirconia implant system is configured to arrange each ceramic crown of the one or more ceramic crowns for each of the one or more one-piece ceramic zirconia dental implants.

17. The full-mouth zirconia implant system of claim 11, wherein the one or more one-piece ceramic zirconia dental implants are placed immediately after tooth extraction.

18. The full-mouth zirconia implant system of claim 11, wherein the temporary restoration is configured to avoid occlusion with the one or more one-piece ceramic zirconia dental implants during the healing period.

19. The full-mouth zirconia implant system of claim 11, wherein the one or more one-piece ceramic zirconia dental implants are placed without significant bone reduction, and wherein the one or more one-piece ceramic zirconia dental implants are properly placed using a surgical guide.

20. The full-mouth zirconia implant system of claim 11, wherein the temporary restoration is fabricated as a U-shaped piece.
